(19) United States
(12) Patent Application Publication
(10) Pub. No.: US 2012/0003030 A1
(43) Pub. Date: Jan. 5, 2012

(54) Tethered Cap For Pens And Markers

(76) Inventors: Louis Kish, Santa ana, CA (US); Jozsef Horvath, Fullerton, CA (US)

(21) Appl. No.: 12/828,215

(22) Filed: Jun. 30, 2010

(51) Int. Cl. B43K 5/00

(52) U.S. Cl. 401/202

(57) ABSTRACT

Novel pen structures for securing pen cap to a pen. A tethering structure is mounted to a securing ring that is mounted on the holding barrel a pen. The attached tether then holds a cap close to the holding barrel and the cap can therefore either be placed over or be removed from the writing tip without being detached from the holding barrel.

### CROSS-REFERENCE

This patent application claims the benefit of U.S. Provisional Application No. 61/221,598 filed on Jun. 30, 2009, the entirety of which is incorporated herein by reference.

### BACKGROUND

The present application relates to pens and markers, and more particularly to pens or markers having a cap that is tethered to the body of the pens or markers.

Note that the points discussed below may reflect the hindsight gained from the disclosed inventions, and are not necessarily admitted to be prior art.

Caps are used on pens (all types of tips) and markers (like the Sharpie® and Dry Erase markers (for white boards) to prevent the ink in the tips from drying up or being damaged.

In order to prevent the pen cap from separating from the pen barrel, complicated cap structures have been designed to accommodate to different types of pen tips, ink solvents. For example, US Application 2010/0040404 A1 describes a pen with a locking cap that includes a storage chamber for accommodating ink liquid for pen's writing tip.

In U.S. Application 2009/0297250 A1 describes a pen cap that has a magnet inside to provide a magnetic force. The pen barrel has a metal element attractable to the magnet. The pen cap and the pen barrel have respectively a first coupling portion and a second coupling portion there correspond to and are couplable with each other. The first and second coupling portions form a first coupling position and a second coupling position. At the first coupling position, the magnet and metal element are connected to form an anchor condition. At the second coupling position, the magnet and metal element are separated to release the anchor condition.

However, even with these complicated cap structure designs, a common problem with these caps with these pens and markers is that the users remove the cap to use the pen, and then lose the cap. The ink dries and the pen/marker becomes useless and must be disposed of prematurely.

### SUMMARY

The present application discloses new approaches to provide pen caps that cannot be lost during usage of the pen or marker.

In one aspect of an embodiment, a tether is attached with the pen cap and is secured on the pen body. The tether may be secured to the trunk of a pen by a ring-like structure.

In another aspect of an embodiment, the barrel of a pen has a tether that is attached or secured to a pen cap.

The user will slide the cap off the tip of a pen, the cap will be tethered and held to the body of the pen while the person writes or marks. The tether will keep the cap conveniently removed from the users grip on the pen, but it will secure the cap so it is readily available. When the user is finished writing or marking, he/she will stretch or extend the tether, and then slide the cap securely onto the tip of the pen/marker.

The disclosed innovations, in various embodiments, provide one or more of at least the following advantages. However, not all of these advantages result from every one of the innovations disclosed, and this list of advantages does not limit the various claimed inventions.

Simple and easy, and can be used with existing pens or markers.

Minimal cost increase in manufacturing and assembly.

Extending the life of pens and markers by providing a cap that will not be lost and prevents the ink tip from being damaged.

### BRIEF DESCRIPTION OF THE DRAWINGS

The disclosed inventions will be described with reference to the accompanying drawings, which show important sample embodiments of the invention and which are incorporated in the specification hereof by reference, wherein:

FIG. 1 shows a perspective view of an example of a tether capped pen in accordance with this disclosure.

FIG. 2 shows a perspective view of another example of a tether capped pen in accordance with this disclosure.

### DETAILED DESCRIPTION OF SAMPLE EMBODIMENTS

The numerous innovative teachings of the present application will be described with particular reference to presently preferred embodiments (by way of example, and not of limitation). The present application describes several inventions, and none of the statements below should be taken as limiting the claims generally.

For simplicity and clarity of illustration, the drawing figures illustrate the general manner of construction, and description and details of well-known features and techniques may be omitted to avoid unnecessarily obscuring the invention. Additionally, elements in the drawing figures are not necessarily drawn to scale, some areas or elements may be expanded to help improve understanding of embodiments of the invention.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition.

It is contemplated and intended that the designs apply to various cap structures for various functions accommodating the specific functions of a pen or marker; for clarity reason, the examples are given based on a simple slide-on pen cap, but an ordinary person in the art would know the variations to modify the design to other types of cap structures.

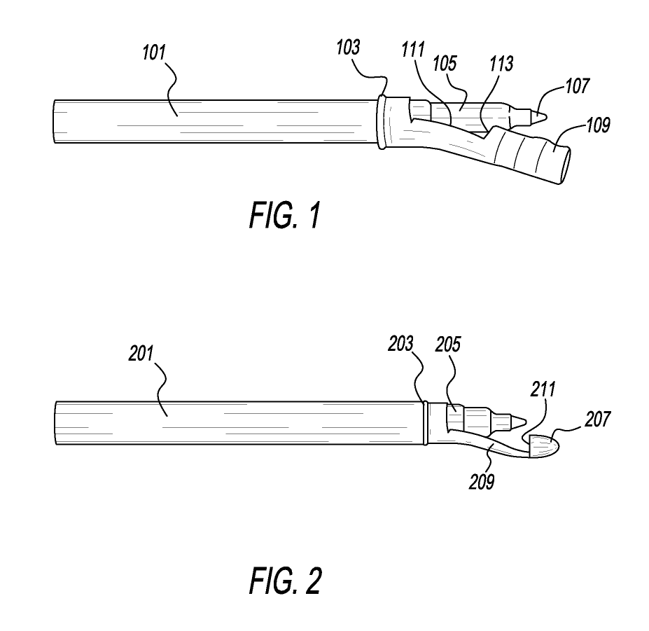

In reference to FIG. 1, pen cap 109 has an extended flexible tether 111 and a securing ring 103. The user may push the securing ring 103 onto body 101 of a pen. The security ring will typically be placed conveniently at the lower part of barrel 101 of the pen/marker so that it will not interfere, or minimally interfere, with the grip of user's writing hand as he/she holds the pen/marker. The ring will be close enough to tip 107 so that the tether can be extended enough for cap 109 to be removed and replaced. Cap 109 fits tightly to the circumference of the lower trunk 105 of the pen and where the cap is not impervious to the ink in the pen, the cap can include a flexible liner or coating of, for example, cellophane or the like, or a flexible inner cap of, for example, polypropylene or the like, each of which is impervious to ink to prevent evaporation of ink from the tip. In those instances where a liner or inner cap is inserted into the cap, the liner or inner cap stays inside the cap during the life of the product. The liner or inner cap can be dome shape to cover the tip of the pen and fit tightly around the barrel 105 at the base of the tip.

The attachment of cap 109 to tether 111 may be as a molded extension of the tether or it may be secured separately to the tether. Tether 111 may be flexible plastic material that can be stretched, or it may be rigid and secured to the cap using a sliding holder that is attached to either the securing ring 103 or the cap.

Securing ring 103 may be made of metal or plastic, it can be placed by pushing onto the pen barrel, or be screwed in between the top barrel and lower barrel of a pen. Securing ring 103 may be designed with a decorative patterns to add a aesthetic touch for a pen user.

Security ring 103 may also clamp onto the body of the pen using spring properties, the ring may not be a complete ring, but a c-shape.

In reference to FIG. 2, tether 209 is a molded integral part of pen barrel 201 or 203. To the tether 209, pen cap 207 can be securely mounted with a ring 211 or loosely attached through an anchor button. Cap 207 fits tightly to the lower part of the pen barrel, for example, 205, sealing the tip from contacting the open air and preventing the evaporation of ink when the pen tip is capped with 207. In those instances where the cap is not impervious to the ink in the pen, the cap can include a flexible liner or coating of, for example, cellophane or the like, or a flexible inner cap of, for example, polypropylene or the like, each of which is impervious to ink to prevent evaporation of ink from the tip. In the embodiment where a liner or inner cap is inserted into the cap, the liner or inner cap stays inside the cap during the life of the product. The liner or inner cap can be dome shape to cover the tip of the pen and fit tightly around the barrel 205 at the base of the tip.

Cap 207 is removed from the tip when using the pen, cap 207 remains attached to the pen, so that it will not be lost.

The tether may be stretchable material and perform like a rubber band, or it may be rigid and held to the cap and or the security ring by mechanical means. The security ring typically is a stretchable material that will conform to the shape of the pen by its elastic nature. The security ring, the tether and the cap may be implemented using single molds with one material for all elements, or an overmolding process that allows using materials with different characteristics for different elements.

A pen may be any type of writing tools, for example, a pencil, a brush, a marker, ball point pen or a metal pen, etc.

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

Additional general background and examples of different cap structures, which helps to show variations and implementations, may be found in US Application 2010/0040404 A1 and U.S. Application 2009/0297250 A1, all of which are hereby incorporated by reference herein for all purposes.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

What is claimed is:

1. A tetherable cap for a writing tool having a writing tip and a holding barrel with the writing tip mountable on the holding barrel, comprising:
a cap having a sealed end and an aperture end wherein the aperture end has a shape that accommodates the holding barrel, is configured to slide over the writing tip and tightly enclose the writing tip, preventing the writing tip from contacting open air;
a securing ring having a circumference that tightly fits with the holding barrel and having a width sufficiently strong to anchor the cap on the writing tool; and
a tether of sufficient length, having a first end and a second end, the first end being secured on the cap and second end being secured on the securing ring;
whereby when the securing ring is mounted on the holding barrel, the attached tether holds the cap close to the holding barrel and the cap can either be placed over or be removed from the writing tip without being detached from the holding barrel.

2. The tetherable cap of claim 1, wherein the securing ring is made of metal.

3. The tetherable cap of claim 1, wherein the securing ring is clamped onto the holding barrel.

4. The tetherable cap of claim 1, wherein the securing ring, the tether are and the cap are molded as one piece.

5. The tetherable cap of claim 1, wherein tether is mounted on the cap and detachable from the cap.

6. The tetherable cap of claim 1, wherein the securing ring is embedded inside the holding barrel.

7. A writing tool with a tethered cap, having a holding barrel and a writing tip with the writing tip mountable on the holding barrel, comprising:
a cap having a sealed end and an aperture end wherein the aperture end accommodates the shape of the holding barrel, is configured to slide over the writing tip and tightly enclose the writing tip, preventing the writing tip from contacting open air; and
a tether of sufficient length, having a first end and a second end, the first end being secured on the cap and second end being secured on the holding barrel;
whereby the tether holds the cap close to the holding barrel and the cap can either be placed over or be removed from the writing tip without being detached from the holding barrel.

8. The writing tool of claim 7, wherein the tether and the holding barrel is molded as one piece.

9. The writing tool of claim 7, wherein the cap is mounted on the tether and detachable from the tether.

10. The writing tool of claim 7, wherein the tether is flexible string secured on an anchoring point on the holding barrel.

11. The writing tool of claim 10, wherein the anchoring point is a hole on the holding barrel.
